(19) United States
(12) Patent Application Publication
(10) Pub. No.: US 2009/0058145 A1
(43) Pub. Date: Mar. 5, 2009

(54) Chassis frame for fuel cell vehicle

(75) Inventor: Chang Wook Park, Gyeonggi-do (KR)

Correspondence Address: Edwards Angell Palmer & Dodge LLP, P.O. Box 55874, Boston, MA, 02205, US

(73) Assignee: Hyundai Motor Company, Seoul (KR)

(21) Appl. No.: 11/999,959

(22) Filed: Dec. 6, 2007

(30) Foreign Application Priority Data
Sep. 3, 2007 (KR) 10-2007-0088767

(51) Int. Cl. B62D 21/18

(52) U.S. Cl. 296/204

(57) ABSTRACT

A chassis frame for a fuel cell vehicle is disclosed. The chassis frame for the fuel cell vehicle is configured to form a lower portion of a vehicle body of a fuel cell vehicle and to form the vehicle body of the fuel cell vehicle together with an upper body. The chassis frame includes: two side members each of which is arranged in a longitudinal direction of the vehicle body and defines at a front part thereof a front kick-up portion; a plurality of cross members transversely arranged between the two side members, wherein the second cross member is located so as to transversely couple the front kick-up portions of the side members and the third cross member is located behind the second cross member in a longitudinal direction so as to transversely couple the side members; and a reinforcing longitudinal member arranged in a longitudinal direction so as to be coupled to the second cross member and the third cross member.

### CROSS-REFERENCE TO RELATED APPLICATION

This application claims the benefit under 35 U.S.C. §119(a) on Korean Patent Application No. 10-2007-0088767, filed on Sep. 3, 2007, the entire contents of which are incorporated herein by reference.

### BACKGROUND

1. Technical Field

The present invention relates to a chassis frame for a fuel cell vehicle, and more particularly, to a chassis frame for a fuel cell vehicle platform configured to form a lower portion of a vehicle body of a fuel cell vehicle.

2. Background Art

Vehicle industry has rapidly grown centering on gasoline and diesel internal combustion engines for more than one hundred years, but it is now confronted by a tremendous change due to problems such as environmental regulations, a threat to energy security and exhaustion of fossil fuel.

Many developed countries have entered into competition of developing future vehicles with environment-friendly, high efficient and high-tech features, and major vehicle companies are trying to survive in such keen competition.

In accordance with the demand of the times for environment-friendly products which can resolve a fossil fuel exhaustion problem, vehicle companies have been actively developing electric vehicles which use an electric motor as a power source.

In this connection, research on a vehicle with a fuel cell system mounted thereon has been actively undergone.

As well known, a vehicle with a fuel cell system supplies hydrogen to a fuel cell stack as fuel to generate electric energy which is used to operate an electric motor to drive a vehicle.

Here, a fuel cell system is a sort of a power generating system which does not change chemical energy in fuel to heat by combustion but electrochemically generates electric energy therein.

A fuel cell system comprises a fuel cell stack for generating electric energy, a fuel supplying system for supplying fuel (hydrogen) to the fuel cell stack, an air supplying system for supplying oxygen in the air as an oxidizer used in an electrochemical reaction, and a heat/water management system for externally discharging reaction heat of the fuel cell stack and controlling a driving temperature of the fuel cell stack.

In such a fuel cell system, electric energy is generated by an electrochemical reaction of hydrogen as fuel and oxygen in the air, generating heat and water as a reaction byproduct.

As a fuel cell system, a proton exchange membrane fuel cell (PEMFC) is widely used due to high output density.

Meanwhile, a conventional fuel vehicle has a vehicle body of a box-type structure called “a monocoque body” which does not have a frame.

The monocoque body is configured by a combination of thin panels and reinforcing members to provide an engine room, a passenger room and a trunk room and is designed to distribute an external force caused in the event of a vehicle crash to the whole body.

In the conventional vehicle body structure, a humidifier for humidifying air supplied to a fuel cell stack, the fuel cell stack for generating electric energy by an electrochemical reaction between hydrogen as fuel and oxygen in the air, and a fuel processing system for controlling pressure of hydrogen supplied from a hydrogen tank to supply hydrogen as fuel are mounted in an engine room of a monocoque body, whereas a plurality of hydrogen tanks are mounted below a rear floor of a monocoque body.

The humidifier and the fuel cell stack mounted in a fuel cell vehicle are very heavy in weight.

If these heavy parts are mounted in the engine room of the monocoque body, a monocoque body configured by combining very thin panels which are mold-manufactured may not endure the strength and, so the monocoque body may become very weak in durability for enduring an external force. That is, providing the monocoque body with sufficient strength requires its structure to be more complicated.

In order to resolve the above problems, as shown in FIG. 1, a vehicle body structure which comprises an upper body (existing monocoque body) 100 and a chassis frame 200 as a dedicated platform for a fuel cell vehicle has been suggested.

The upper body 100 is configured by combining thin panels and reinforcing members to provide an engine room, a passenger room, and a trunk room. The upper body 100 comprises a roof 101, a filler 102, a fender 103, a hood 104, a trunk lid (not shown), a dash panel (not shown), a center floor 105, and a rear floor 106 which are made by molding thin panels, like the monocoque body of an internal combustion engine.

The chassis frame 200 comprises a plurality of longitudinal members and a plurality of transverse members. The chassis frame 200 includes two side members 210 as longitudinal members. It also includes a plurality of cross members 222 and 223 as transverse members, which are arranged between the side members 210. In addition, it includes bumper reinforcing members 231 and 232.

That is, the chassis frame 200 for forming a lower portion of the vehicle body is arranged to apply a frame body of the fuel cell vehicle and forms a vehicle body of the fuel cell vehicle together with the upper body 100. In the chassis frame 200, main fuel cell system parts such as a humidifier 11, a fuel cell stack 12, a FPS 13, and a hydrogen tank 14 are mounted.

The chassis frame 200 is provided with a plurality of body mounting portions 217. The upper body 100 is to be coupled to the chassis frame 200 through the body mounting portions 217.

The chassis frame is described below in more detail with reference to FIGS. 2 and 3.

As shown in FIGS. 2 and 3, the chassis frame 200 includes the longitudinal members, the transverse members connected to longitudinal members and a plurality of body mounting portions 217 through which the chassis frame 200 and the upper body 100 are coupled.

The chassis frame 200 comprises two side members 210. as longitudinal members, which are arranged in a front-rear direction of the vehicle body, first to fourth cross members 221 to 224 arranged, as transverse members, in a transverse direction between the two side members 210, front and rear bumper reinforcing members 231 and 232, and additional reinforcing members (not shown).

Each side member 210 comprises three divisional frame units: a front member 211, a center member 212 and a rear member 213. These three members are sequentially connected in a longitudinal direction to form each side member 210.

The first to fourth cross members 221 to 224 transversely arranged between the two side members 210 are welding-coupled to the side members 210.

Each side member 210 has kick-up portions 214 and 215 to lower the height of the center floor portion of the upper body 100. The kick-up portions 214 and 215 are formed such that a rear portion of the front member 211 and a front portion of the rear member 213 which are connected by the center member 212 are inclined downwards as shown in FIG. 3. That is, the kick-up portions 214 and 215 are formed by a height difference between each of the front and rear members 211 and 213 and the center member 212.

In more detail, as shown in FIG. 3, the front kick-up portion 214 is formed by a height difference between the front member 211 and the center member 212 of the side member 210, and the rear kick-up portion 215 is formed by a height difference between the center member 212 and the rear member 213 of the side member 210.

The height of the front member 211, the center member 212 and the rear member 213 depends on a vehicle layout. That is, the height of the front member 211 and the rear member 213 is determined by a structure of a suspension member, and the height of the center member 212 is determined in consideration of the requirement of enough distance between the upper body and the center floor.

In FIG. 2, a reference numeral 218 denotes a reinforcing member coupled between the front kick-up portion 214 of the side member 210 and the third cross member 223 to reinforce the front kick-up portion 214.

However, the above-described chassis frame has the following problems.

If a front offset crash occurs, the chassis frame 200 gets bent in the front kick-up portion 214 as shown in FIG. 4, which causes an ability for absorbing crash energy to be degraded and a crash performance to be deteriorated.

Even though the reinforcing member 218 is installed to reinforce the front kick-up portion 214, it cannot reinforce the front kick-up portion 214 sufficiently because the front kick-up portion 214 easily gets bent at or near a position where a front part of the suspension arm bracket 218 is.

As an alternative way to prevent the bending, the kick-up amount (i.e., height difference between respective sections of the side member) can be reduced by lowering the height of the front member 211 of the side member 210 and/or raising the height of the center member 212. But it is realistically difficult due to a limitation on a vehicle layout.

That is, as shown in FIG. 5, the height of the front member 211 of the side member 210 is set between 16 inches and 20 inches, and it is difficult to adjust the height of the center member 212 of the side member 210 since an enough distance with the center floor of the upper body should be secured.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to solve the aforementioned problems associated with prior arts and one object of the present invention is to provide a chassis frame for a fuel cell vehicle platform in which a reinforcing structure for a front kick-up portion of a side member is improved.

In one aspect, the present invention provides a chassis frame for a fuel cell vehicle configured to form a lower portion of a vehicle body of a fuel cell vehicle and to form the vehicle body of the fuel cell vehicle together with an upper body, comprising: two side members each of which is arranged in a longitudinal direction of the vehicle body and defines at a front part thereof a front kick-up portion; a plurality of cross members transversely arranged between the two side members, wherein the second cross member is located so as to transversely couple the front kick-up portions of the side members and the third cross member is located behind the second cross member in a longitudinal direction so as to transversely couple the side members; and a reinforcing longitudinal member arranged in a longitudinal direction so as to be coupled to the second cross member and the third cross member.

In a preferred embodiment, the reinforcing longitudinal member is further coupled to the front kick-up portion of the side member.

In another preferred embodiment, the reinforcing longitudinal member is provided with flanges at both ends thereof and the flanges are welded to the second cross member and the third cross member.

In still another preferred embodiment, the reinforcing longitudinal member is provided with a protruding portion on a front end side portion thereof and the protruding portion is connected to the front kick-up portion of the side member.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

Other aspects of the invention are discussed infra.

### BRIEF DESCRIPTION OF THE DRAWINGS

The above and other features of the present invention will be described in reference to certain exemplary embodiments thereof with reference to the attached drawings in which:

FIG. 1 is a perspective view illustrating a vehicle body structure of a fuel cell vehicle which comprises an upper body and a chassis frame according to a conventional art;

FIGS. 2 and 3 are plane and side views illustrating a conventional chassis frame;

FIGS. 4 and 5 are views illustrating a problem of the chassis frame of FIGS. 2 and 3;

FIG. 6 is a plane view illustrating a reinforcing structure for a front kick-up portion of the chassis frame for a fuel cell vehicle according to the exemplary embodiment of the present invention;

FIG. 7 is a side view illustrating the chassis frame of FIG. 6;

FIG. 8 is an enlarged perspective view illustrating a state that a reinforcing longitudinal member is installed as a reinforcing structure for the front kick-up portion of FIG. 6; and

FIG. 9 shows that a crash performance can be improved when the inventive chassis frame is employed in the fuel cell vehicle.

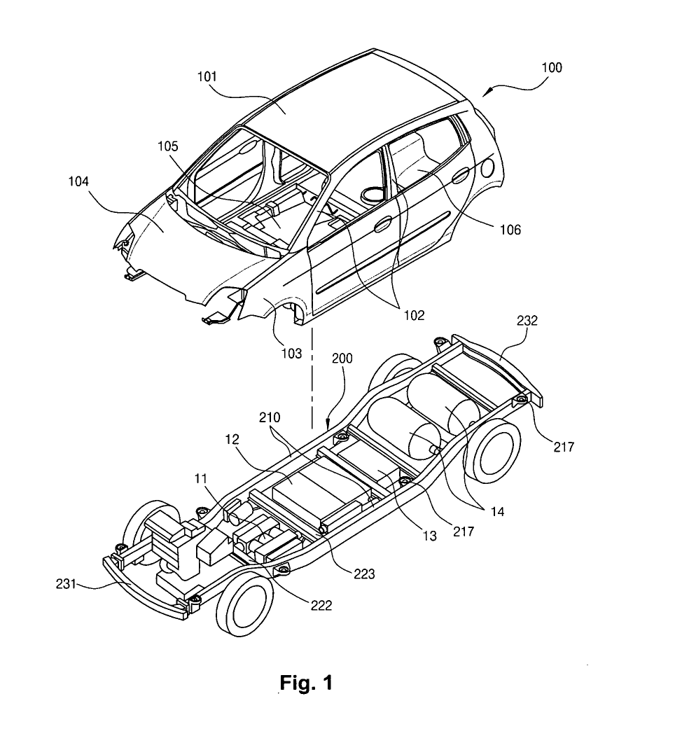

### DETAILED DESCRIPTION

Reference will now be made in detail to the embodiments of the present invention, examples of which are illustrated in the accompanying drawings, wherein like reference numerals refer to the like elements throughout. The embodiments are described below in order to explain the present invention by referring to the figures.

In a chassis frame for a fuel cell vehicle according to an exemplary embodiment of the present invention, a reinforcing longitudinal member is lengthily connected in a longitudinal direction between a second cross member and a third cross member to reinforce a front kick-up portion.

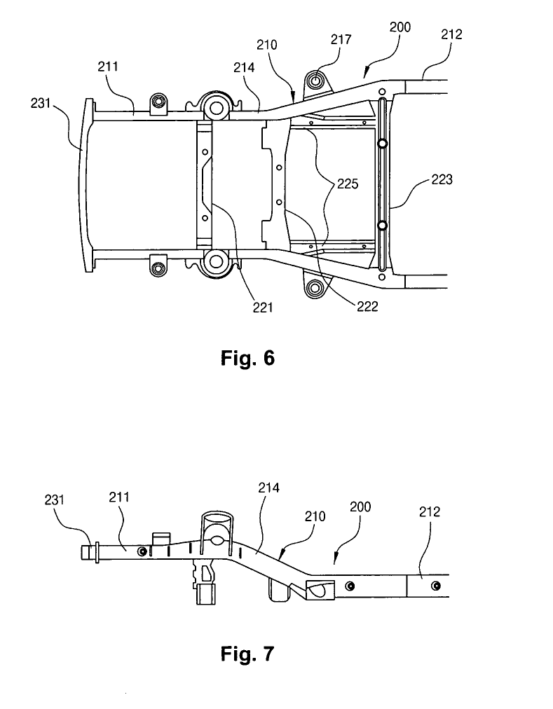

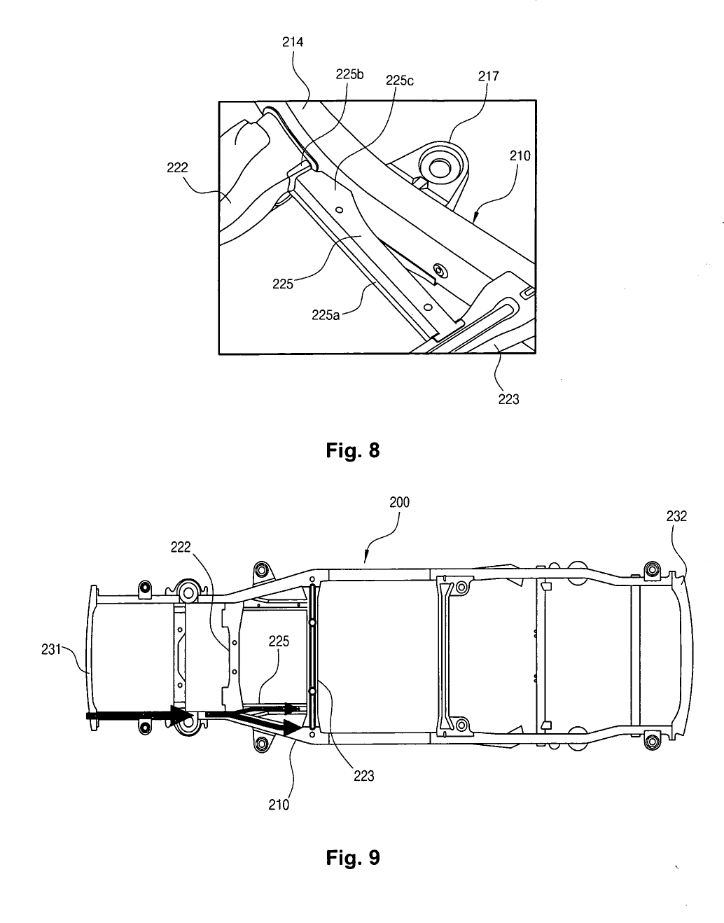

FIG. 6 is a plane view illustrating the reinforcing structure for the front kick-up portion of the chassis frame for a fuel cell vehicle according to the exemplary embodiment of the present invention, FIG. 7 is a side view illustrating the chassis frame of FIG. 6, and FIG. 8 is an enlarged perspective view illustrating a state that a reinforcing longitudinal member is installed as the reinforcing structure for the front kick-up portion of FIG. 6.

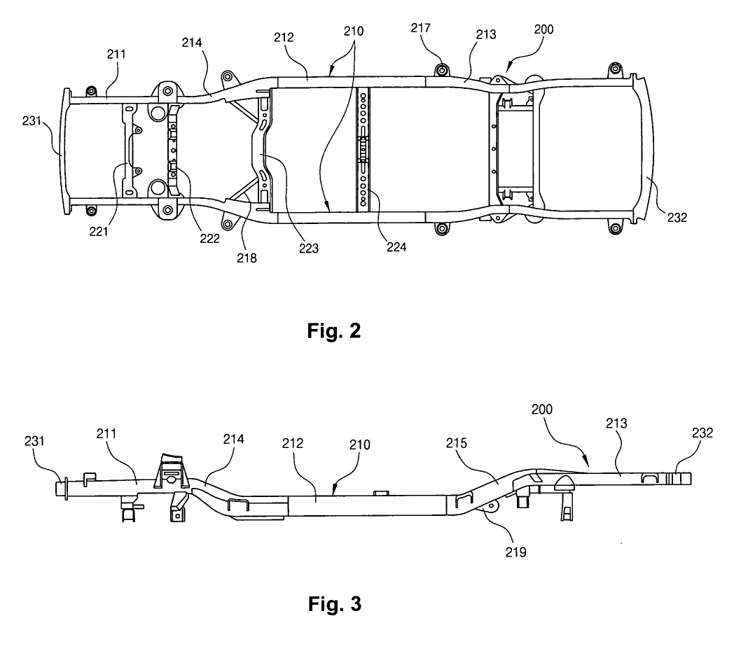

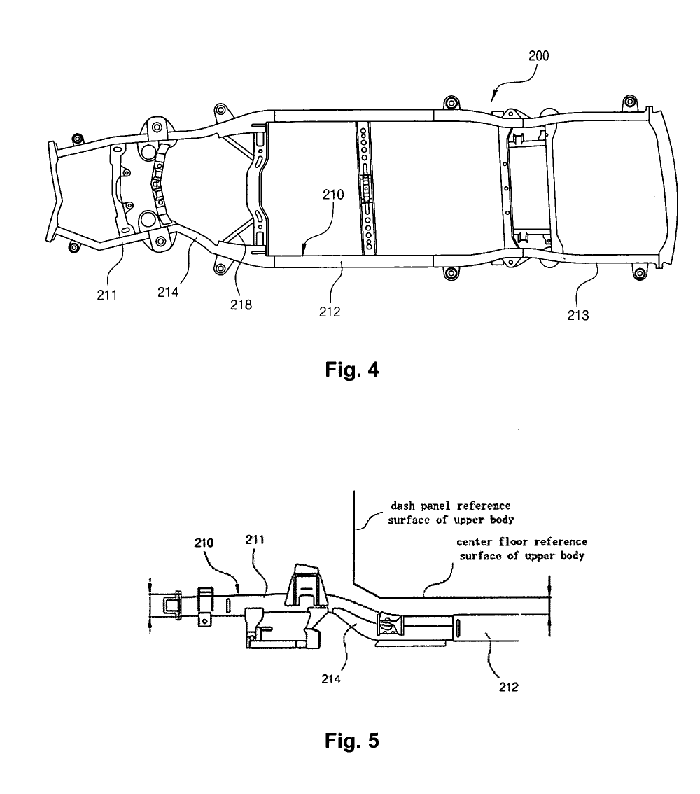

As shown in the drawings, a second cross member 222 arranged between both side members 210 is located at a position closer to the center member 212 compared to that of the chassis frame of FIG. 2.

The second cross member 222 is installed at or near a position where the front kick-up portions 214 are located and the second cross member 222 transversely couples the front kick-up portions 214 of both side members 210.

A third cross member 223 is installed behind the second cross member 222 in a longitudinal direction of the vehicle and the third cross member 223 transversely couples both side members 210.

Reinforcing longitudinal members 225 are installed between the second and third cross members 222 and 223 in a longitudinal direction of the vehicle to reinforce the front kick-up portions 214 of the side members 210.

The reinforcing longitudinal member 225 is made by molding a panel with the predetermined thickness. The reinforcing longitudinal member 225 comprises a flange 225a formed along edges thereof in a longitudinal direction. It also comprises flanges 225b formed on both ends thereof, which are welded with the second and third cross members 222 and 223.

In a preferred embodiment of the present invention, the reinforcing longitudinal member 225 is provided with a protruding portion 225c formed on a front end side portion thereof, which is welded to the second cross member 222 and is coupled to a side of the front kick-up portion 214 of the side member 210. That is, the reinforcing longitudinal member 225 is coupled to the second cross member 222, the third cross member 223, and the front kick-up portion 214 of the side member 210.

In the conventional vehicle body structure of the fuel cell vehicle that the monocoque body (upper body) is mounted on the chassis frame, there are problems in that it is difficult to raise the height of a center floor reference surface of the monocoque body due to a characteristic of a dedicated platform and a height difference between the front member and the center member of the side member is big. In contrast, according to the chassis frame of the present invention, the reinforcing longitudinal members 225 for coupling the three members are installed to reinforce the front kick-up portion 214, thereby efficiently resolving the problem in that the front kick-up portion 214 gets bent by a crash.

FIG. 9 shows that a crash performance can be improved when the present chassis frames are employed in the fuel cell vehicle. Flow of crash energy is distributed primarily through the upper body and the chassis frame and additionally through the reinforcing longitudinal member 214 as shown in FIG. 9, thereby improving a crash performance.

As described above, according to the present invention, the chassis frame can efficiently prevent the front kick-up portion from being bent in the event of a front crash since the reinforcing longitudinal members longitudinally couples the cross members while reinforcing the front kick-up portion of each side member, thereby improving a crash performance of the vehicle body.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

What is claimed is:

1. A chassis frame 200 for a fuel cell vehicle, which is configured to form a lower portion of a vehicle body of the fuel cell vehicle, the chassis frame (200) comprising:
two side members (210) each of which is arranged in a longitudinal direction of the vehicle body and defines at a front part thereof a front kick-up portion (214);
a plurality of cross members (221, 222, 223, 224) transversely arranged between the two side members (210), wherein the second cross member (222) is located so as to transversely couple the front kick-up portions (214) of the side members (210) and the third cross member (223) is located behind the second cross member (222) in a longitudinal direction so as to transversely couple the side members (210); and
a reinforcing longitudinal member (225) arranged in a longitudinal direction so as to be coupled to the second cross member (222) and the third cross member (223).

2. The chassis frame for the fuel cell vehicle of claim 1, wherein the reinforcing longitudinal member (225) is coupled to the front kick-up portion (214) of the side member (210).

3. The chassis frame for the fuel cell vehicle of claim 1, wherein the reinforcing longitudinal member (225) is provided with flanges (225b) at both ends thereof and the flanges (225b) are welded to the second cross member (222) and the third cross member (223).

4. The chassis frame for the fuel cell vehicle of claim 1, wherein the reinforcing longitudinal member (225) is provided with a protruding portion (225c) on a front end side portion thereof and the protruding portion (225c) is connected to the front kick-up portion (214) of the side member (210).
